(19) United States
(12) Patent Application Publication
(10) Pub. No.: US 2010/0223813 A1
(43) Pub. Date: Sep. 9, 2010

(54) Hydro-Mechanical Shoe

(76) Inventor: Türketap Öztürk, Izmir (TR)

Correspondence Address: AKERMAN SENTERFITT, P.O. BOX 3188, WEST PALM BEACH, FL, 33402-3188, US

(21) Appl. No.: 12/682,177

(22) PCT Filed: Oct. 8, 2008
(86) PCT No.: PCT/TR08/00117

§ 371 Date: Apr. 8, 2010

(30) Foreign Application Priority Data
Oct. 8, 2007 (TR) 2007/06912

(51) Int. Cl. A43B 3/00

(52) U.S. Cl. 36/105

(57) ABSTRACT

This invention relates to a hydro-mechanical shoe which generates electrical energy while walking.

### THE RELATED ART

The invention relates to a hydro-mechanical shoe which generates electrical energy while walking.

### THE PRIOR ART

In a short time, not more than 100 years, the damages that fossil fuels made on the nature and on the living organisms have shown their effects. While resources, such as coal, natural gas and petroleum, which were formed in thousands of years, have been rapidly depleted, air, soil and water have also started to be exhausted by their wastes. The hazards of what is known as fossil fuels, namely, coal, petroleum and natural gas, were not only limited to the immediate surroundings; but they have also spread to the atmosphere. In the end, this pollution has started to cause climatic changes and threaten the life on earth. All such negative impacts have oriented people to look for new forms of energy and to utilization of renewable energy sources. The idea of charging mobile electronic devices independently of the main energy system is a part of a vision of the future, the vision that the individual generates the electrical energy he/she needs to charge the batteries of electronic devices by the most natural act of the daily life, the act of walking, and that he/she will become independent of the main energy distribution system in this matter as well and become free. Nowadays, the shoe models which produce mechanical electric are the models, which include a great number of parts (gear wheels, springs etc.), require the dimensions of the soles to be large, have high risk of deformation, and have limitations in terms of the force that can be transmitted since the resistance values of the parts to be used need to be observed.

The models of the known status of the art are the ones which could not be put into mass production. Since these models comprising a great number of parts are found inside elastic structures such as soles, they are affected from sole deformation that occurs during usage and they can not work effectively. In order for these large numbers of mechanical parts to be placed inside the sole and operate without failure, the sole has to be made in sizes greater than normal sizes and this condition, as well as increasing the weight of the shoes; it also has negative impacts on walking comfort and shoe aesthetics. In the mechanical and pneumatic models used in the prior art, it is not possible to achieve high revolution and rotational moment.

Moreover, in these models, within the strength limitations of the small mechanical parts that transmit the force, generation of a turning moment (torque) involves difficulties. Because of these difficulties, the production phase involves highly detailed and complicated processes and is considerably long and expensive.

The hydraulic model, which is the subject matter of the invention, comprises very few parts and since the system preferably uses oil of suitable viscosity as the fluid, it does not comprise any wearable parts other than the hydraulic motor pinions. Its expected life is as long as the time that the rubber sole maintains its characteristics. Its production costs are low and this model, having a hydraulic structure, generates an amount of energy so high that it can be stored. Furthermore, in the hydraulic model, the torque received from the hydro-motor can be increased by increasing the accumulator gas pressure.

In the International patent document no WO 0221955 taking place in the known status of the art, a shoe is disclosed, which converts mechanical energy into electrical energy via the mechanical parts placed under its heel section, and thus, which can perform a self-heating or illumination operation while walking without taking external electrical energy.

### BRIEF DESCRIPTION OF THE INVENTION

The purpose of this invention is to develop a shoe which would convert the motion, in other words, the pressure generated while walking, into electrical energy via the hydro-mechanical system placed inside the shoe and thus which would generate electricity.

### DETAILED DESCRIPTION OF THE INVENTION

A hydro-mechanical shoe created to satisfy the object of this invention is shown in the figures and in these figures;

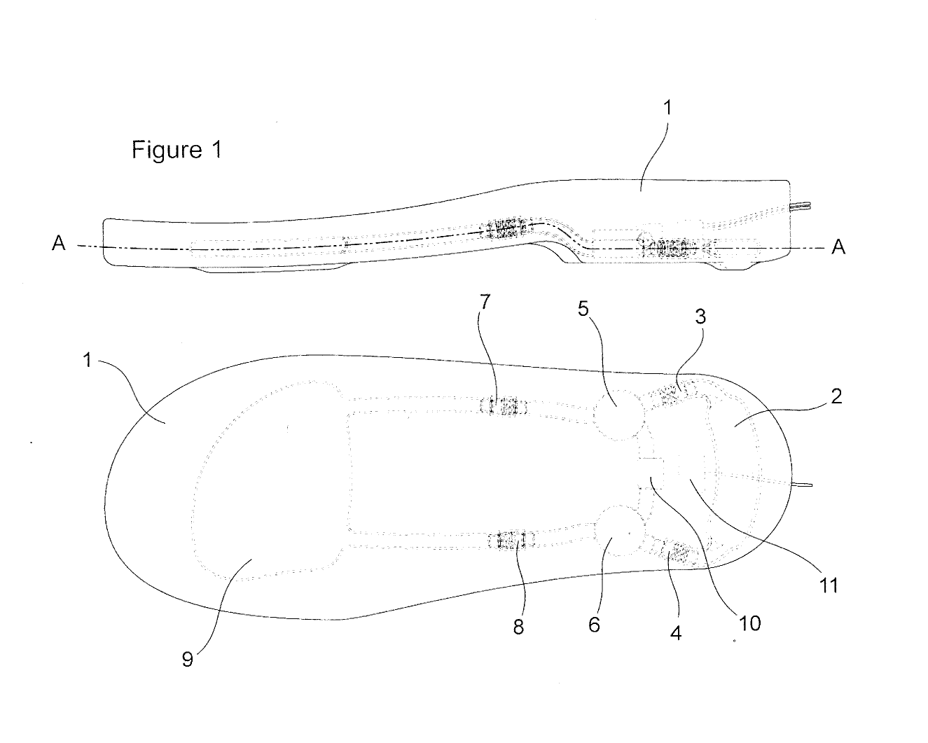

FIG. 1—is the section view of the hydro-mechanical shoe.

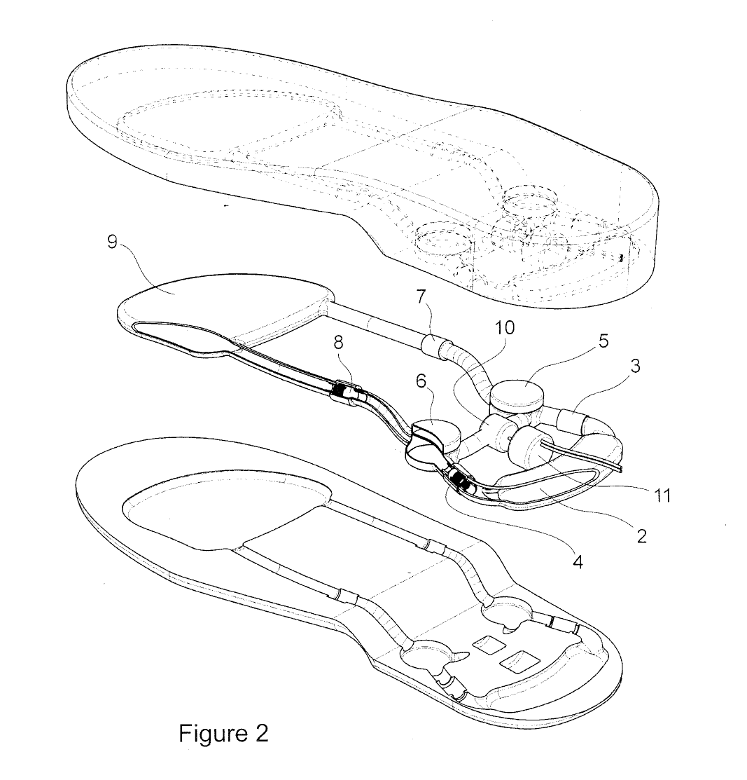

FIG. 2—is the section view of the hydro-mechanical shoe.

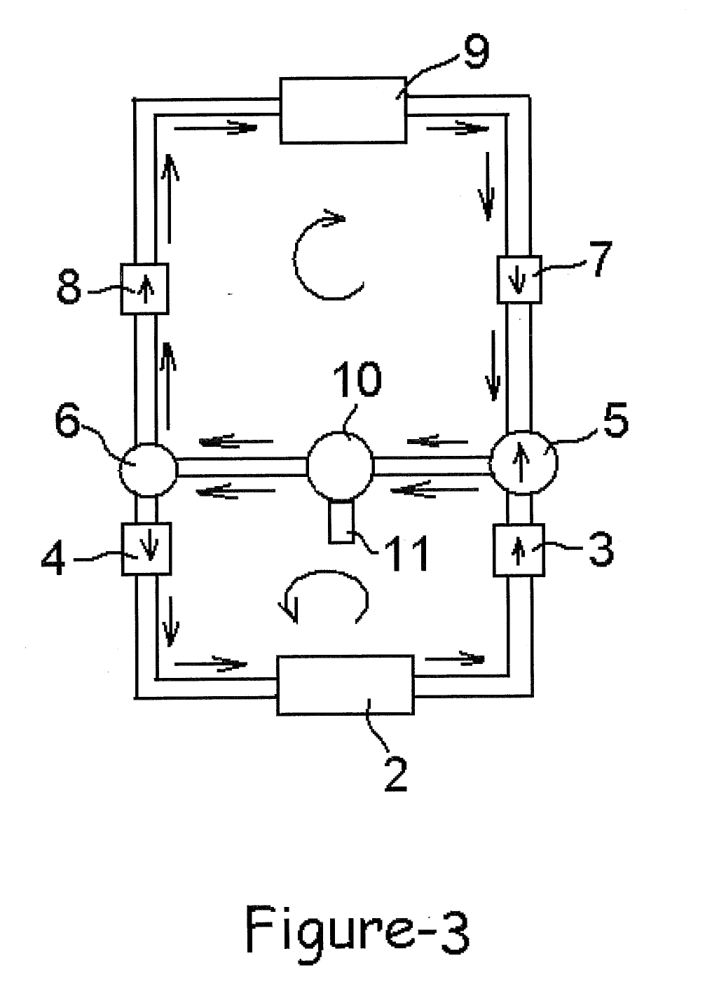

FIG. 3—is the schematic view of the operating system of the hydro-mechanical shoe.

### REFERENCE NUMBERS

1. Hydro-mechanical shoe
2. Heel hydraulic housing
3. Check-valve-1
4. Check valve-2
5. Hydraulic accumulator 1
6. Hydraulic accumulator 2
7. Check valve-3
8. Check valve-4
9. Front hydraulic housing
10. Hydro-motor
11. Dynamo

The hydro-mechanical shoe (1), which is the subject of the invention, comprises in its basic form, at least one heel hydraulic housing (2) which is located at the heel section of the shoe and in which the fluid is stored, at least one check-valve 1 (3) and check-valve 2 (4) which ensure a one-way passage of the fluid towards the accumulators when the heel section is pressed on, at least one hydraulic accumulator 1 (5) and hydraulic accumulator 2 (6) which provide that the pressurized fluid coming from the check valves are accumulated at a certain volume and provide feeding of the hydraulic circuit with this fluid when required, at least one front hydraulic housing (9) which is located at the front section of the shoe (1) and which is the place where the fluid is stored in the front section, at least one check-valve 3 (7) and check-valve 4 (8) which ensure a one-way passage of the fluid towards the accumulators when pressure is formed on the front section of the shoe, at least one hydro-motor (10) which generates circular motion with the pressurized fluid, or in other words, with the hydro-mechanical energy coming from the accumulators, and it comprises at least one dynamo (11) which converts the circular motion into electrical energy.

The accumulators (5,6) used here have a structure which stores the fluid and works as a diaphragm, or in other words, volume of which increases when pressure is increased, and volume of which decreases when pressure is decreased.

When pressed on, certain zones in the hydro-mechanical shoe (1) sole increase the pressure by moving and changing shape and by compressing the fluid, preferably the oil, found in the heel hydraulic housing (2) of their upper volume and the front hydraulic housing (9). These fluid housings located at the front and the rear sections of the shoe sole are placed at locations where the pressure and motion are the most frequent. In this way, maximum efficiency is obtained from the pressure motion at the foot while walking. The function of these housings is to store the fluid, preferably the oil, which is required for the hydro-mechanical system positioned in the sole of the shoe. At the moment of the beginning of movement, the pressurized oil coming from the hydro-mechanical housings, passes through the control check valves (3,4,7,8) which provide the one-way flow. The check-valves (3,4,7,8) are also referred as various names such as non-return valves or ratchet valves. The said check-valves (3,4,7,8) permit one way passage of the fluid; however, they do not permit their passage towards the other direction. The fluid, preferably the oil, passing through the check-valves (3,4,7,8) reaches the hydraulic accumulator 1 (5) and the hydraulic accumulator 2 (6). The hydraulic accumulators generally provide collection of the pressurized fluid within a certain volume and feeding of the hydro-mechanical circuit with this fluid when required. In hydro-mechanical systems, when a large quantity of fluid is needed for a short period of time, accumulators are used as the storages of the fluid. The fluid with increasing pressure in the hydraulic accumulators (5,6) goes to the hydro-motor (10). The hydro-motor (10) provides generation of circular motion with hydraulic energy. It uses the pressurized fluid coming from the hydraulic accumulator 1 (5) and the hydraulic accumulator 2 (6). Its operation principle is the opposite of pumps. Pumps convert mechanical energy into hydraulic energy whereas motors convert hydraulic energy into mechanical energy. The circular motion produced by the hydro-motor (10) is converted to electrical energy via the dynamo (11). In this way, the conversion of the hydraulic energy, obtained during walking, into electrical energy is completed. The hydro-mechanical shoe (1) is designed in a way that the circulation of the fluid would not be cut even when the foot is lifted off the ground. For that purpose, at least two hydraulic accumulators (5,6) are positioned before and after the hydro-motor (10). The maximum oil storage volumes of the hydraulic accumulators (5,6) are designed in a way that they would be equal to half of the total volume of oil found in the heel hydraulic housing (2) and the front hydraulic housing (9). Thus, when the foot is fully pressed on the ground, all of the fluid in the housings is transferred to the accumulators (5,6), and in the meantime, by virtue of the design, half of the volume of the fluid produces work by being transferred through the hydro-motor (10).

When a foot is lifted off the ground the pressurized fluid in the accumulators before the hydro-motor (10) passes through the hydro-motor (10) and the cyclic continuity is thus ensured.

When a foot is lifted off the ground, the pressurized fluid in the accumulator which is found before the hydro-motor (10) passes through the hydro-motor (10) and thus the continuity of circulation is provided. When the heel part of the foot is pressed on the ground while walking, the fluid found in the heel hydraulic housing (2) at the heel, passes through the one way control valve, which is check-valve 1 (3) and then it is filled into the hydraulic accumulator 1 (5) and hydraulic accumulator 2 (6) in equal amounts. Meanwhile, the fluid, having increased pressure and charging hydraulic accumulator 2 (6), passes through hydro-motor (10) and produces work.

While walking, when a foot is fully pressed on the ground, the fluid found in the front hydraulic housing (9) in the front part passes through the one-way flow control valve check-valve 3 (7), and fills into the hydraulic accumulator 1 (5) and the hydraulic accumulator 2 (6). Similarly the pressurized fluid charging the hydraulic accumulator 2 (6) passes through the hydro-motor (10) and produces work. When the foot is fully pressed on the ground while walking, all of the oil found in the heel and the front housing (2,9) is displaced and they are in a position that they have charged the two accumulators (5,6).

While walking, when a foot is being lifted off the ground, first the pressure in the heel section is relieved and the heel hydraulic housing (2) is filled with the oil coming from the accumulators (5,6), and in the meantime, half of the displaced fluid volume passes through the hydro-motor and produces work. When the foot is completely lifted, the front hydraulic housing (9) located at the front section is filled with the oil, that comes from the hydraulic accumulator 1 (5) and the hydraulic accumulator 2 (6) after passing through and the one-way flow control valve, which is the check-valve 4 (8). Meanwhile, the fluid coming from the hydraulic accumulator 2 (6) produces work by turning the hydro-motor (10).

The maximum oil storage volumes of the hydraulic accumulators are designed to be half of the total volume of oil displaced in the front and the heel hydraulic housings (2,9) when the foot is fully pressed on the ground. When this feature is combined with the design, the cyclic continuity is not disrupted when the foot is pressed on and lifted off from the ground.

In FIG. 3, the schematic view of the working system of the hydro-mechanical shoe is given. When the user, wearing the hydraulic shoe, presses on the heel section, therefore the heel hydraulic housing of the shoe;
The fluid found at the heel moves towards the direction that the valves permit, or in other words, towards the valve (3);
The fluid, first tries to fill the accumulator (5) and then it is forced to move between the accumulator (5) and the accumulator (6);
Meanwhile, the fluid generates rotating motion by actuating the motor (10) positioned between the accumulator (5) and the accumulator (6). This rotating motion is converted to electrical energy via the dynamo (11) which is connected to the motor.
The fluid coming from the motor (10) fills the accumulator (6);
Then it goes to the front hydraulic housing (9) during the time while the heel is pressed on.

When the heel is pressed on, or in other words, when the heel hydraulic housing (2) is pressed on, the fluid with the amount equal to the volume closed at the heel, increases the volume of the accumulator (5) and the accumulator (6). Here, the accumulators (5,6) used have a structure which stores the fluid and works as a diaphragm, or in other words, volume of which increases when pressure is increased, and volume of which decreases when pressure is decreased.

When the pressure of the foot moves from the heel (from the heel hydraulic housing (2)) to the front part, the movement is as below described;
With the pressure given to the fluid first by the accumulator (5) and then by the accumulator (6), the fluid moves towards the heel hydraulic housing (2).

When the pressure of the foot moves towards the front hydraulic housing;
The fluid found in the front hydraulic housing (2) moves towards the direction that the check valves permit, or in other words passes through the check valve (7) and first fills the accumulator (5) and then increases the pressure of the said accumulator (5);
By moving from the accumulator (5) to the motor (10), the fluid ensures the motor (10) make rotating motion and produces electricity. This rotating motion is converted to electrical energy via the dynamo (11) connected to the motor (10).
Afterwards, the fluid comes to the accumulator (6) and fills the said accumulator (6);
The fluid reaching the accumulator (6) and trying to increase the pressure there, would try to fill the heel hydraulic housing (2) while the pressure is maintained at the front hydraulic housing (9);

From the moment when the foot is lifted off, or in other words, from the moment when the pressure on the front hydraulic housing (9) starts to decrease and until it finishes, the fluid found in the accumulator (6) is forced to fill the front hydraulic housing (9) and the heel hydraulic housing (2) via the pressure effect.

In this way, since the pressure of the liquid found inside the accumulator (5) would be higher than the other accumulator (6), the fluid found inside the accumulator (5) is forced towards the accumulator (6). This cycle continues until the pressure inside the closed circulation is balanced at all points. During a normal walk, the second step would be taken before this cycle completely finishes. In this way, the fluid is forced to continuous motion and rotates the motor (10) which is connected to the dynamo (11) and thus ensures production of electrical energy.

Moreover, hydraulic accumulators (5,6) having a diaphragm structure are used. The said accumulators (5,6) ensure continuous circulation during the four phases of walking (when the heel is pressed on the ground, when the foot is completely pressed on the ground, when the heel is moved away from the ground, and when the foot is lifted off the ground). In a sense, the hydro-motor, and therefore the dynamo (11) are continuously fed.

The hydro-mechanical shoe (1) can perform charging of all mobile electrical devices with a simple electrical connection made with the dynamo (11) which converts the rotational energy to electrical energy. With a simple heating apparatus to be added, it may easily be used for heating the foot of the user. The energy generated can be used to charge machines which operate in a group and each of which perform different functions. The electricity generated by the hydro-mechanical shoe can be used for heating clothes.

1. A hydro-mechanical shoe comprising:
comprises, in its most rudimentary form,
at least one heel hydraulic housing which is found at the heel section of the shoe and which is the place where the fluid is stored in the heel section;
at least one first check-valve and second check-valve which ensure the one-way transfer of the fluid to the accumulators when the heel section is pressed on;
at least one first hydraulic accumulator and second hydraulic accumulator which ensure collection of the pressurized fluid coming from the check-valves within a certain volume and feeding of the hydraulic circuit with this fluid when required;
at least one front hydraulic housing which is located in the front section of the shoe and which is the place where the fluid is stored in the front section;
at least one third check-valve and fourth check-valve which provide one-way transfer of the fluid towards the accumulators when pressure is formed in the front section of the shoe; and
at least one hydro-motor which produces rotational motion with the pressurized fluid the hydraulic energy coming from the accumulators, the hydro-motor comprising at least one dynamo which converts the rotational motion into electrical energy.

2. The hydro-mechanical shoe according to claim 1, comprising:
a dynamo which can heat the foot of the user, provide charging of devices such as mobile phone, radio telephone, radio or a lighting device with electric connection in all four phases when the heel is pressed on the ground, when the foot is completely pressed on the ground, when the heel is lifted off the ground and when the foot is completely lifted off the ground; which can maintain fluid circulation continuously; and which converts rotating motion into electrical energy.

3. The hydro-mechanical shoe according to claim 2, which provides pressure to the fluid in order to provide increase in the torque taken from the hydro-motor when the gas pressures of the hydraulic accumulators are increased.

4. The hydro-mechanical shoe according to claim 2, comprising materials having a high durability.

5. The hydro-mechanical shoe according to claim 4, wherein the materials are hard plastics or metal which achieve high hydraulic pressures and torques via the front hydraulic housing and the heel hydraulic housing.

6. The hydro-mechanical shoe according to claim 2, which ensures actuation of more than one hydro-motor, and which provides maintaining continuous fluid circulation using forces with changing magnitudes and impact times.
